(19) United States
(12) Patent Application Publication
(10) Pub. No.: US 2023/0308362 A1
(43) Pub. Date: Sep. 28, 2023

(54) SECURITY WEB APPLICATION LAYOUTS AND TILES

(71) Applicant: Johnson Controls Tyco Holdings LLP, Milwaukee, WI (US)

(72) Inventors: Robert PEARSON, Dover, MA (US); Sanela SULJIC, Nashua, NH (US)

(21) Appl. No.: 18/187,363

(22) Filed: Mar. 21, 2023

Related U.S. Application Data
(60) Provisional application No. 63/322,516, filed on Mar. 22, 2022.

(51) Int. Cl. H04L 41/22; G06F 9/451; G06F 3/0484; H04L 67/02

(52) U.S. Cl. CPC H04L 41/22; G06F 9/451; G06F 3/0484; H04L 67/02

(57) ABSTRACT

Examples described herein generally relate to a system for generating a web application user interface for a security system. The system may receive a selection of an interface component and a location for the interface component on a layout for the web application user interface from a user via a graphic user interface, the interface component associated with one or more security devices via a security server. The system may receive, via the graphic user interface, a configuration of an action for the interface component with respect to the one or more security devices. The system may display the interface component on the web application user interface, wherein the interface component communicates with the one or more security devices via the security server in real time. The system may receive input for the one or more security devices from the user via the web application user interface.

### CROSS-REFERENCE TO RELATED APPLICATIONS

This application claims priority to U.S. Provisional Application No. 63/322,516 titled “SECURITY WEB APPLICATION LAYOUTS AND TILES,” filed Mar. 22, 2022, which is assigned to the assignee hereof, and incorporated herein by reference in its entirety.

### BACKGROUND

The present disclosure relates to web application layouts and tiles for security systems.

Security systems provide various devices to improve physical security of a location. For example, a security system may include security devices such as cameras, identification readers, and various types of doors. As the number of devices and functionality of each device in a security system expands, the task for a human (e.g., a security administrator or security guard) to monitor individual devices may become more difficult. For example, a security system may include tens or hundreds of cameras, so a user interface for displaying all of the camera feeds or interacting with the cameras may be cumbersome.

In an example scenario, a security administrator or security guard may be responsible for monitoring a security system and responding to calls from personnel. For example, an employee may need assistance if an identification reader does not correctly read a card. In a large system with multiple security devices, a security administrator may need to navigate through multiple lists to locate the relevant devices in order to confirm the issue and remotely open a door for the employee. As another example, during an event, the security administrator may want to monitor a particular set of security devices, but an interface may include excess information.

Thus, there is a need in the art for improvements in security system user interfaces. In particular, there is a need for systems and methods for customizing a security system user interface.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In some aspects, the techniques described herein relate to a method of generating a web application user interface for a security system, including: receiving a selection of a first interface component and a location for the interface component on a layout for the web application user interface from a user via a graphic user interface, the first interface component associated with one or more security devices via a security server; receiving, via the graphic user interface, a configuration of an action for the first interface component with respect to the one or more security devices; displaying the first interface component on the web application user interface, wherein the interface component communicates with the one or more security devices via the security server in real time; and receiving input for the one or more security devices from the user via the web application user interface.

In some aspects, the techniques described herein relate to a method, wherein the interface component is a card configured to display a real-time result of a query to the security server.

In some aspects, the techniques described herein relate to a method, further including deploying the web application user interface to a client device.

In some aspects, the techniques described herein relate to a method, wherein the layout for the web application user interface defines a plurality of predefined positions, wherein receiving the selection of the first interface component includes receiving a selection of a size of the first interface component as a number of the plurality of predefined positions.

In some aspects, the techniques described herein relate to a method, further including: receiving a selection of a second interface component and a second location for the second interface component on the layout for the web application user interface from the user via the graphic user interface, the interface component associated with one or more security devices via the security server; receiving, via the graphic user interface, a configuration of a second action for the second interface component with respect to the one or more security devices; and displaying the second interface component on the web application user interface along with the first interface component.

In some aspects, the techniques described herein relate to a method, wherein the first interface component is a swipe and show interface component that displays a record of users providing identification to the one or more security devices.

In some aspects, the techniques described herein relate to a method, wherein the graphical user interface includes a plurality of selectable buttons for selecting an interface component, wherein each button corresponds to one or more of: an event interface component configured to display events detected by one or more of the security devices; an identification interface component configured to display information associated with an identification reader; a personnel monitoring interface component configured to display information about a person; a device action interface component configured to receive input to manually control a security device; a system monitoring interface component configured to display system statistics; a video monitoring interface component configured to display and control one or more video feeds; an alert interface component configured to generate an alert; or a card interface component configured to present a result of a database query.

In some aspects, the techniques described herein relate to an apparatus for generating a web application user interface for a security system, including: a memory storing computer-executable instructions; and at least one processor coupled to the memory and configured to execute the instructions to: receive a selection of a first interface component and a location for the interface component on a layout for a web application user interface from a user via a graphic user interface, the first interface component associated with one or more security devices via a security server; receive, via the graphic user interface, a configuration of an action for the first interface component with respect to the one or more security devices; display the first interface component on the web application user interface, wherein the interface component communicates with the one or more security devices via the security server in real time; and receive input for the one or more security devices from the user via the web application user interface.

In some aspects, the techniques described herein relate to an apparatus, wherein the interface component is a card configured to display a real-time result of a query to the security server.

In some aspects, the techniques described herein relate to an apparatus, wherein the at least one processor is configured to execute the instructions to deploy the web application user interface to a client device.

In some aspects, the techniques described herein relate to an apparatus, wherein the layout for the web application user interface defines a plurality of predefined positions, wherein receiving the selection of the first interface component includes receiving a selection of a size of the first interface component as a number of the plurality of predefined positions.

In some aspects, the techniques described herein relate to an apparatus, wherein the at least one processor is configured to execute the instructions to: receive a selection of a second interface component and a second location for the second interface component on the layout for the web application user interface from the user via the graphic user interface, the interface component associated with one or more security devices via the security server; receive, via the graphic user interface, a configuration of a second action for the second interface component with respect to the one or more security devices; and display the second interface component on the web application user interface along with the first interface component.

In some aspects, the techniques described herein relate to an apparatus, wherein the first interface component is a swipe and show interface component that displays a record of users providing identification to the one or more security devices.

In some aspects, the techniques described herein relate to an apparatus, wherein the graphical user interface includes a plurality of selectable buttons for selecting an interface component, wherein each button corresponds to one or more of: an event interface component configured to display events detected by one or more of the security devices; an identification interface component configured to display information associated with an identification reader; a personnel monitoring interface component configured to display information about a person; a device action interface component configured to receive input to manually control a security device; a system monitoring interface component configured to display system statistics; a video monitoring interface component configured to display and control one or more video feeds; an alert interface component configured to generate an alert; or a card interface component configured to present a result of a database query.

In some aspects, the techniques described herein relate to a security system including: one or more security devices configured to monitor an area and control access to the area; a security server configured to receive information from the one or more security devices and issue commands to the one or more security devices; a node server configured to: receive a selection of a first interface component and a location for the interface component on a layout for a web application user interface from a first user via a graphic user interface, the first interface component associated with one or more security devices via a security server; receive, via the graphic user interface, a configuration of an action for the first interface component with respect to the one or more security devices; and a client device configured to: display the first interface component on the web application user interface, wherein the interface component communicates with the one or more security devices via the security server in real time; and receive input for the one or more security devices from a second user via the web application user interface.

In some aspects, the techniques described herein relate to a security system, wherein the interface component is a card configured to display a real-time result of a query to the security server.

In some aspects, the techniques described herein relate to a security system, wherein the node server is configured to deploy the web application user interface to the client device.

In some aspects, the techniques described herein relate to a security system, wherein the layout for the web application user interface defines a plurality of predefined positions, wherein the node server is configured to receive a selection of a size of the first interface component as a number of the plurality of predefined positions.

In some aspects, the techniques described herein relate to a security system, wherein the first interface component is a swipe and show interface component that displays a record of users providing identification to the one or more security devices.

In some aspects, the techniques described herein relate to a security system, wherein the graphical user interface includes a plurality of selectable buttons for selecting an interface component, wherein each button corresponds to one or more of: an event interface component configured to display events detected by one or more of the security devices; an identification interface component configured to display information associated with an identification reader; a personnel monitoring interface component configured to display information about a person; a device action interface component configured to receive input to manually control a security device; a system monitoring interface component configured to display system statistics; a video monitoring interface component configured to display and control one or more video feeds; an alert interface component configured to generate an alert; or a card interface component configured to present a result of a database query.

The present disclosure also provides an apparatus (e.g., a computer device) including a memory storing computer-executable instructions and at least one processor configured to execute the computer-executable instructions to perform the above methods, an apparatus including means for performing the above methods, and a non-transitory computer-readable medium storing computer-executable instructions for performing the above methods.

Additional advantages and novel features relating to implementations of the present disclosure will be set forth in part in the description that follows, and in part will become more apparent to those skilled in the art upon examination of the following or upon learning by practice thereof.

### DESCRIPTION OF THE FIGURES

In the drawings:

FIG. 1 is a diagram of an example security system including a network that connects security devices to a security server.

FIG. 2 is an example architecture 200 for implementing the network of FIG. 1.

FIG. 3 is an example of a graphical user interface (GUI) for generating a layout including interface components.

FIG. 4 is an example of the GUI of FIG. 3 including multiple interface components in the layout.

FIG. 5 is an example of a web application user interface based on the layout of FIG. 4.

FIG. 6 is a diagram of an example computer device that may be used to implement a security server or a node server providing an interface to the security server.

FIG. 7 is a flowchart of an example method of generating a web application user interface for a security system.

FIG. 8 is a diagram of an example computer device in accordance with an implementation, including additional component details as compared to FIG. 6.

### DETAILED DESCRIPTION

The present disclosure provides systems and methods for deploying customizable web application interfaces for a security system in real-time.

Current techniques for providing interfaces to security systems is for the security system provider to develop an interface and deploy the interface to sites as an application. Deployment of the application at a site may include downtime for the system as new interfaces are added.

In an aspect, a graphical user interface allows a user such as a security administrator (admin) to select interface components and arrange the interface components in a layout. The interface components may be based on an application programing interface (API) and or software development kit (SDK) compatible with a security server. The API or SDK may provide requirements for interacting with the security system. The interface components may be verified and approved for use with the security system before being added to a library that is accessible to different users. The graphical user interface allows the admin to configure each interface component. For example, the admin may associate the interface component with one or more security devices. The customized layout may be deployed instantly for use by the admin or another user such as a security guard. Accordingly, the present disclosure may reduce downtime of a security system or user interface thereof. Further, the present disclosure improves the user interface of the security system by allowing quick and convenient customization of the user interface for particular deployments or scenarios. For example, the admin may develop a user interface for monitoring or controlling a particular room by selecting appropriate interface components based on the needs for an event that is planned for the room. The customized user interface may be deployed to a client device such as a security terminal or a mobile device of a security guard.

During operation, the interface component may communicate with one or more security devices via the security server in real time. For example, the interface component may present a video feed from a camera, door lock/unlock events, or identification events. The customization of the user interface may allow the user interface to display relevant information and controls without the need for a user to sort through menus and device lists in real time.

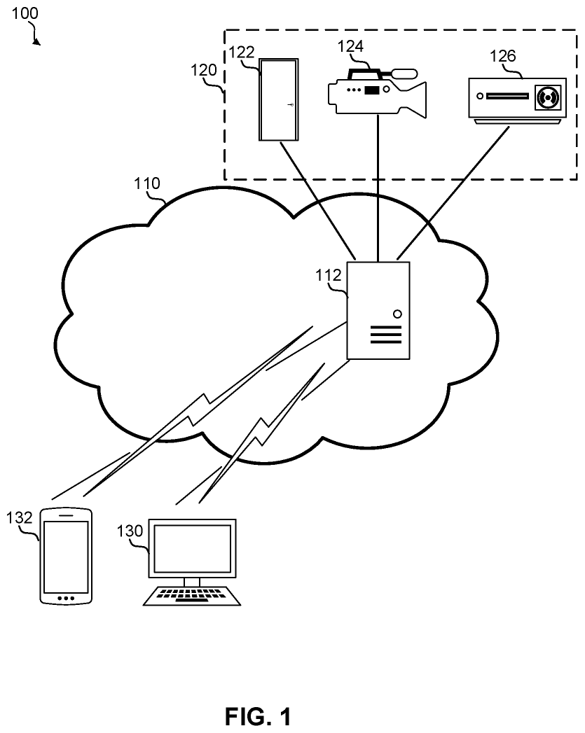

Referring now to FIG. 1, an example security system 100 includes a network 110 that connects security devices 120 to a security server 112. For example, the security device 120 may include example devices such as a door 122, a camera 124, and an identification reader 126. The security server 112 may be configured to control the security devices 120. For example, the security server 112 may be configured to receive information from the security devices 120 and issue commands to the security devices 120. The security devices may monitor an area and/or control access to an area. For example, the door 122 may control physical access to an area by allowing people to enter the area through the door. The door 122 may include a lock that can be controlled remotely via commands from the security server 112. For example, various doors 122 may be configured to unlock in response to a respective identification reader 126 sending identification information to the security server 112, which determines whether the identification information matches information for authorized personnel and issues an unlock command to the door 122. The cameras 124 may be positioned in strategic locations and provide video feeds to the security server 112.

Security personnel such as admins and guards may access the security system 100 and the security server 112 via client devices such as a terminal 130 or a mobile device 132. In an aspect, the present disclosure provides for configuration of a web application that may be accessed via the user devices for the security personnel to interact with the security system.

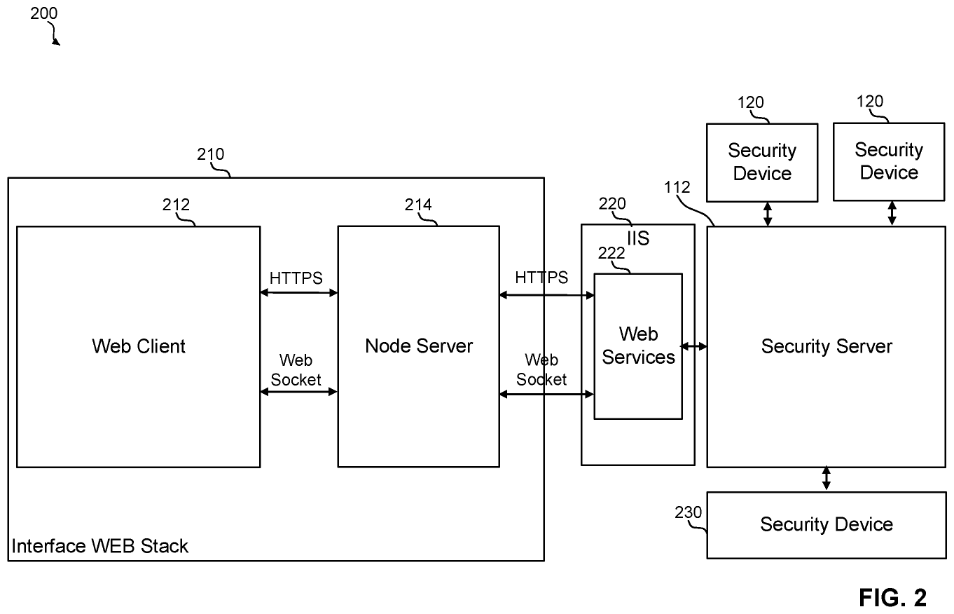

Turning to FIG. 2, an example architecture 200 may implement the network 110. The network 110 may include a web stack 210 that provides an interface for the client devices including terminal 130 and mobile device 132. In particular, the web stack 210 includes a web client 212 that may execute on a user device. The web client 212 may securely communicate with a node server 214, for example, via HTTPS or web sockets. For instance, the user may be authenticated as a registered user of the security system and may be associated with a particular role or access privileges. The web stack 210 may communicate with the security server 112 via an internet information services (IIS) 220 that provides web services 222. In some implementations, the web services 222 may be referred to as a node server. The web services 222 may include authentication, user and operator roles, access control, data services, site management, and video transport.

The security server 112 may be connected to multiple security devices 120, for example, using wired connections at a secured location and/or secured connections to a remote location. The security server 112 may be connected to a database server 230 that stores data for the security system such as video and event records. The security server 112 may access the database server 230 to provide information requested via the web client 212. In an aspect, the web stack 210, IIS 220, and security server 112 may be implemented in one location or distributed across multiple locations.

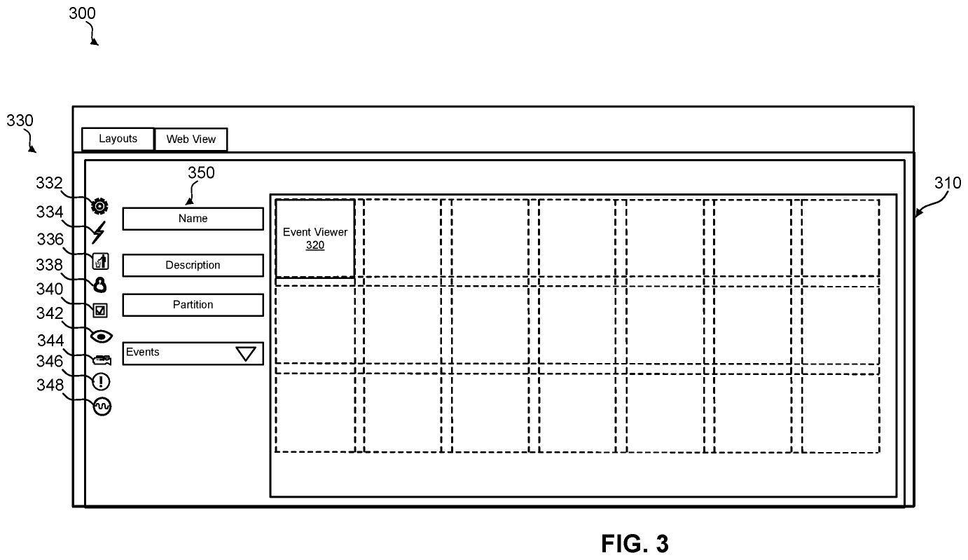

FIG. 3 is an example of a graphical user interface (GUI) 300 for generating a layout 310 including interface components 320. The layout 310 may be represented as a grid structure including a plurality of predefined positions. Other structures for the plurality of predefined positions may be defined for alternative layouts. The GUI 300 may allow the user to place an interface component 320 on the layout 310 at a desired location. The user may resize the interface components 320. Accordingly, the user may arrange the interface components 320 to create a layout that allows security personnel to accomplish a task.

The GUI 300 may include buttons 330 indicating options for interface components. A configuration button 332 may bring up an interface for configuring a selected interface component 320. An events button 334 may provide an interface component for viewing events detected by one or more of the security devices 120. For instance, the interface component may be configured to filter a stream of detected events and present events matching configured criteria (e.g., employee arrivals). A swipe and show button 336 may provide an interface component for monitoring information associated with an identification reader 126 such as scanned personnel identifiers, timestamps, and approve/deny decisions. A personnel monitoring button 338 may provide an interface component that provides information about a person. A device action button 340 may provide an interface component for controlling a security device 120. For example, a device action interface component may be configured to lock or unlock a door. In another implementation, the device action button 340 may link to another layout or external source of information. A system button 342 may provide an interface component for monitoring system information. For example, the system information may include summary statistics or performance of the security server 112. A video monitoring button 344 may provide an interface component for monitoring one or more video feeds. For example, the interface component may be configured to provide a video feed from one or more specific cameras. An alert button 346 may provide an interface component for generating an alert. For example, the interface component may allow the operator to manually trigger an alert or configure the alert based on monitored conditions. The interface component may also provide configuration options to select parties or devices that receive the alert. A data intelligence button 348 may provide an interface component for viewing data, for example, in the form of a card. The interface component may be configurable to execute a query on the security server 112 and display the result on the card.

The GUI 300 may include a settings panel 350. The setting panel 350 may provide text boxes or other input features for defining characteristics of an interface component. For example, the setting panel 350 may include a title box and a description box. In some implementations, the setting panel 350 may include options for selecting a size of the interface component 320. For example, the size may be indicated as a number of predefined locations (e.g., 2×2) within the layout 310.

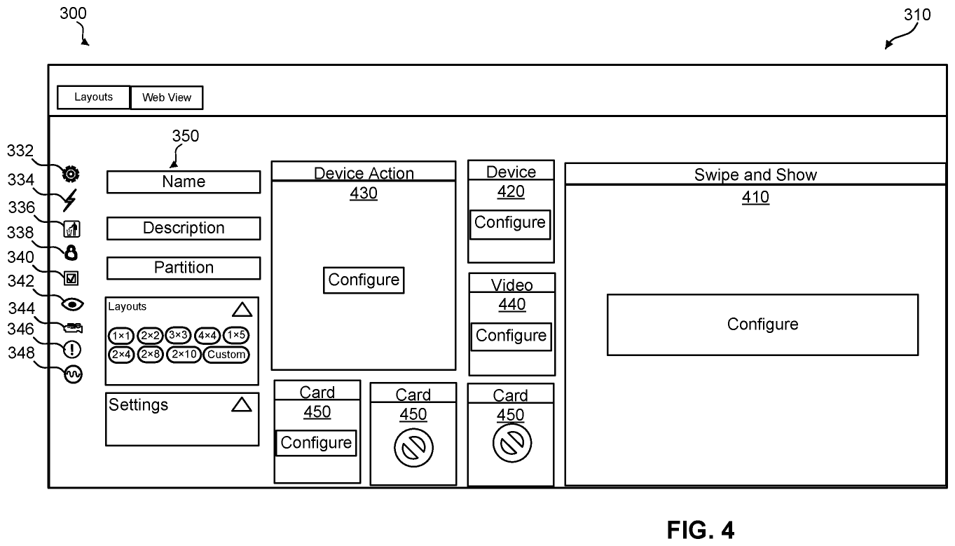

FIG. 4 an example of the GUI 300 including multiple interface components 320 in the layout 310. The user interface components may be selected to perform a certain task. An example use case may include identifying people in an area to determine whether there is a security risk. The layout 310 may include a swipe and show interface component 410 that allows a user to see a record of users providing identification within the area. The layout 310 may include a device action interface component 420 configured to remotely lock or unlock a door. The layout 310 may include another device action button 430 that may be configured to, for example, trigger an alarm. The layout 310 may include a video monitoring interface component 440 that may display a video feed for a particular camera. For example, the camera may be oriented toward the door controlled by the identification reader. Accordingly, a security guard may review video in the video monitoring interface component 440 to confirm that the person identified by the identification reader is present at the door and should be allowed to pass before unlocking the door via the action interface component 420.

In some implementations, the layout 310 may include a card interface component 450 that is configured to present particular information. For instance, the card interface component 450 may be configured to present the result of a database query such as a number of people in an area, or a number of unlocked doors.

In some implementations, when an interface component is added to the layout 310 in the GUI 300, the interface component may include a configure button. Each interface component may be associated with a separate configuration interface. For example, the configuration interface may allow the user to select the security device(s) 120 that provide information to the interface component or can be controlled via the interface component. The configuration interface may also allow definition of a database query, for example, via a variable tracked by security server 112 or a formula defined by such variables.

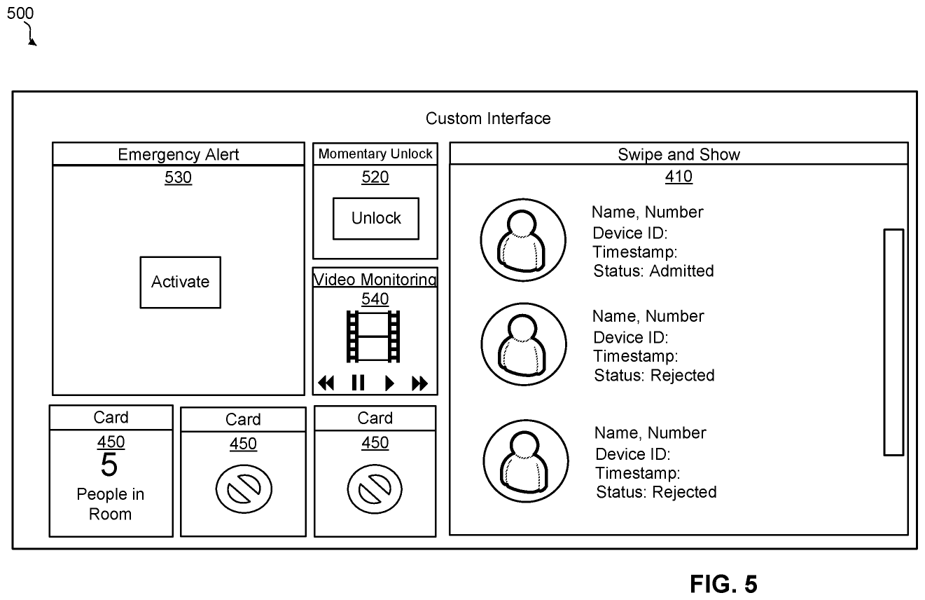

FIG. 5 is an example of a web application user interface 500 based on the layout 310 of FIG. 4. A swipe and show interface component 510 displays a record of users providing identification within the area. The interface component 510 may allow a user to view a video of the identification event, unlock a related door, or change the status of the personnel associated with the event. The device action interface component 520 allows the user to momentarily unlock a door. The device action button 530 allows the user to trigger an emergency alert. The video monitoring interface component 540 displays a video feed. The card interface component 550 presents a number of unlocked doors.

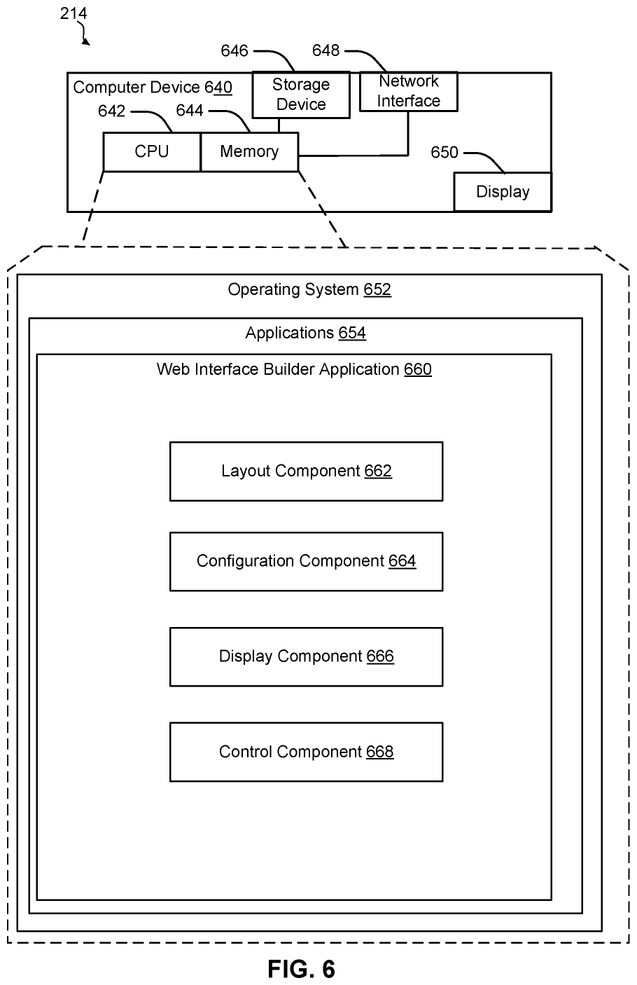

Turning to FIG. 6, an example computer device 640 may be used to implement the security server 112 or a node server 214 providing an interface to the security server 112. The computer device 640 may include a central processing unit (CPU) 642 that executes instructions stored in memory 644. For example, the CPU 642 may execute an operating system 652 and one or more applications 654, which may include a web interface builder application 660. The computer device 640 may include a storage device 646 for storing data (e.g., from security devices 120). The computer device 640 may also include a network interface 648 for communication with external devices via a network. For example, the computer device 640 may communicate with the security devices 120.

The computer device 640 may include a display 650. The display 650 may be, for example, a computer monitor and/or a touch-screen. The display 650 may provide information to an operator and allow the operator to configure the computer device 640.

Memory 644 may be configured for storing data and/or computer-executable instructions defining and/or associated with an operating system 652 and/or application 654, and CPU 642 may execute operating system 652 and/or application 654. Memory 644 may represent one or more hardware memory devices accessible to computer device 640. An example of memory 644 can include, but is not limited to, a type of memory usable by a computer, such as random access memory (RAM), read only memory (ROM), tapes, magnetic discs, optical discs, volatile memory, non-volatile memory, and any combination thereof. Memory 644 may store local versions of applications being executed by CPU 642. In an implementation, the memory 644 may include a storage device, which may be a non-volatile memory.

The CPU 642 may include one or more processors for executing instructions. An example of CPU 642 can include, but is not limited to, any processor specially programmed as described herein, including a controller, microcontroller, application specific integrated circuit (ASIC), field programmable gate array (FPGA), system on chip (SoC), or other programmable logic or state machine. The CPU 642 may include other processing components such as an arithmetic logic unit (ALU), registers, and a control unit. The CPU 642 may include multiple cores and may be able to process different sets of instructions and/or data concurrently using the multiple cores to execute multiple threads.

The operating system 652 may include instructions (such as applications 654) stored in memory 644 and executable by the CPU 642. The applications 654 may include a web interface builder application 660 configured to generate a web application user interface for a security system. In an aspect, the web interface builder application 660 may include a layout component 662 configured to receive a selection of an interface component 320 and a location for the interface component on a layout 310 for the web application user interface 500 from a user via a graphic user interface 300. The interface component 320 may be associated with one or more security devices 120 via a security server 112. The web interface builder application 660 may include a configuration component 664 configured to receive, via the graphic user interface, a configuration of an action for the interface component with respect to the one or more security devices. The web interface builder application 660 may include a display component 666 configured to display the interface component on the web application user interface. The interface component may communicate with the one or more security devices via the security server in real time. The web interface builder application 660 may include a control component 668 configured to receive input for the one or more security devices from the user via the web application user interface.

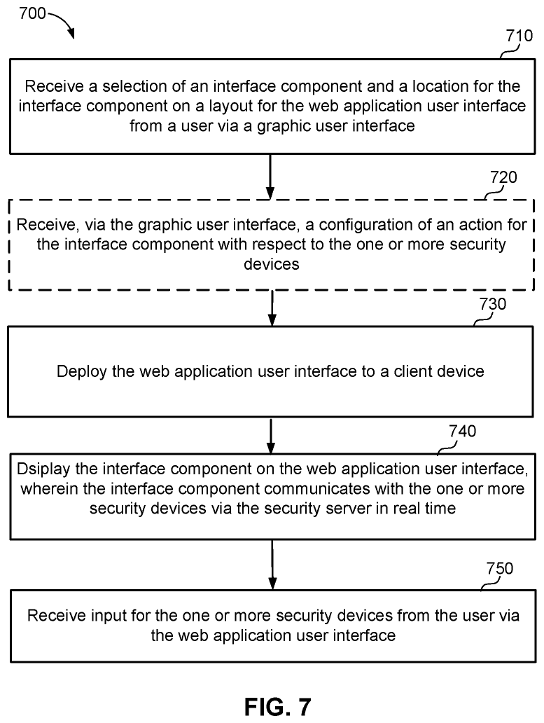

Turning to FIG. 7, an example method 700 generates a web application user interface for a security system. For example, method 700 may be performed by the web interface builder application 660 on the computer device 640. Optional blocks are shown with dashed lines.

At block 710, the method 700 may include receiving a selection of an interface component and a location for the interface component on a layout for the web application user interface from a user via a graphic user interface, the interface component associated with one or more security devices via a security server. For example, the user may use the buttons 330

At block 720, the method 700 may include receiving, via the graphic user interface, a configuration of an action for the interface component with respect to the one or more security devices.

At block 730, the method 700 may include deploying the web application user interface to a client device.

At block 740, the method 700 may include displaying the interface component on the web application user interface, wherein the interface component communicates with the one or more security devices via the security server in real time.

At block 750, the method 700 may include receiving input for the one or more security devices from the user via the web application user interface.

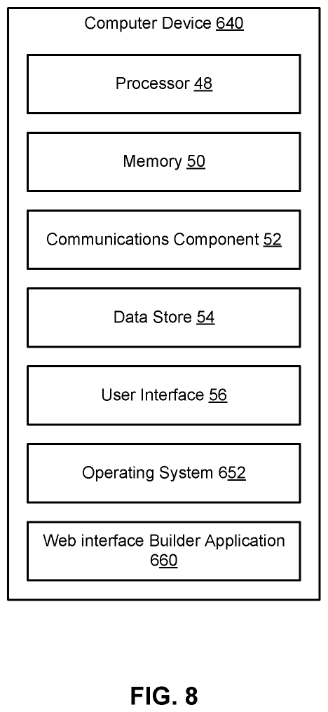

Referring now to FIG. 8, illustrated is an example computer device 640 in accordance with an implementation, including additional component details as compared to FIG. 6. In one example, computer device 640 may include processor 48 for carrying out processing functions associated with one or more of components and functions described herein. Processor 48 can include a single or multiple set of processors or multi-core processors. Moreover, processor 48 can be implemented as an integrated processing system and/or a distributed processing system. In an implementation, for example, processor 48 may include CPU 642.

In an example, computer device 640 may include memory 50 for storing instructions executable by the processor 48 for carrying out the functions described herein. In an implementation, for example, memory 50 may include memory 644. The memory 50 may include instructions for executing the web interface builder application 660.

Further, computer device 640 may include a communications component 52 that provides for establishing and maintaining communications with one or more parties utilizing hardware, software, and services as described herein. Communications component 52 may carry communications between components on computer device 640, as well as between computer device 640 and external devices, such as devices located across a communications network and/or devices serially or locally connected to computer device 640. For example, communications component 52 may include one or more buses, and may further include transmit chain components and receive chain components associated with a transmitter and receiver, respectively, operable for interfacing with external devices.

Additionally, computer device 640 may include a data store 54, which can be any suitable combination of hardware and/or software, that provides for mass storage of information, databases, and programs employed in connection with implementations described herein. For example, data store 54 may be a data repository for operating system 652 and/or applications 654. The data store may include memory 644 and/or storage device 646.

Computer device 640 may also include a user interface component 56 operable to receive inputs from a user of computer device 640 and further operable to generate outputs for presentation to the user. User interface component 56 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, user interface component 56 may include one or more output devices, including but not limited to a display, a speaker, a haptic feedback mechanism, a printer, any other mechanism capable of presenting an output to a user, or any combination thereof.

In an implementation, user interface component 56 may transmit and/or receive messages corresponding to the operation of operating system 652 and/or applications 654. In addition, processor 48 may execute operating system 652 and/or applications 654, and memory 50 or data store 54 may store them.

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computer device and the computer device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various implementations or features may have been presented in terms of systems that may include a number of devices, components, modules, and the like. A person skilled in the art should understand and appreciate that the various systems may include additional devices, components, modules, etc. and/or may not include all of the devices, components, modules etc. discussed in connection with the figures. A combination of these approaches may also be used.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computer devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or procedure described in connection with the implementations disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some implementations, the processor and the storage medium may reside in an ASIC. Additionally, the ASIC may reside in a user terminal. In the alternative, the processor and the storage medium may reside as discrete components in a user terminal. Additionally, in some implementations, the steps and/or actions of a method or procedure may reside as one or any combination or set of codes and/or instructions on a machine readable medium and/or computer readable medium, which may be incorporated into a computer program product.

In one or more implementations, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While implementations of the present disclosure have been described in connection with examples thereof, it will be understood by those skilled in the art that variations and modifications of the implementations described above may be made without departing from the scope hereof. Other implementations will be apparent to those skilled in the art from a consideration of the specification or from a practice in accordance with examples disclosed herein.

What is claimed is:

1. A method of generating a web application user interface for a security system, comprising:
receiving a selection of a first interface component and a location for the interface component on a layout for the web application user interface from a user via a graphic user interface, the first interface component associated with one or more security devices via a security server;
receiving, via the graphic user interface, a configuration of an action for the first interface component with respect to the one or more security devices;
displaying the first interface component on the web application user interface, wherein the interface component communicates with the one or more security devices via the security server in real time; and
receiving input for the one or more security devices from the user via the web application user interface.

2. The method of claim 1, wherein the interface component is a card configured to display a real-time result of a query to the security server.

3. The method of claim 1, further comprising deploying the web application user interface to a client device.

4. The method of claim 1, wherein the layout for the web application user interface defines a plurality of predefined positions, wherein receiving the selection of the first interface component comprises receiving a selection of a size of the first interface component as a number of the plurality of predefined positions.

5. The method of claim 1, further comprising:
receiving a selection of a second interface component and a second location for the second interface component on the layout for the web application user interface from the user via the graphic user interface, the interface component associated with one or more security devices via the security server;
receiving, via the graphic user interface, a configuration of a second action for the second interface component with respect to the one or more security devices; and
displaying the second interface component on the web application user interface along with the first interface component.

6. The method of claim 1, wherein the first interface component is a swipe and show interface component that displays a record of users providing identification to the one or more security devices.

7. The method of claim 1, wherein the graphical user interface comprises a plurality of selectable buttons for selecting an interface component, wherein each button corresponds to one or more of:
an event interface component configured to display events detected by one or more of the security devices;
an identification interface component configured to display information associated with an identification reader;
a personnel monitoring interface component configured to display information about a person;
a device action interface component configured to receive input to manually control a security device;
a system monitoring interface component configured to display system statistics;
a video monitoring interface component configured to display and control one or more video feeds;
an alert interface component configured to generate an alert; or
a card interface component configured to present a result of a database query.

8. An apparatus for generating a web application user interface for a security system, comprising:
a memory storing computer-executable instructions; and
at least one processor coupled to the memory and configured to execute the instructions to:
receive a selection of a first interface component and a location for the interface component on a layout for a web application user interface from a user via a graphic user interface, the first interface component associated with one or more security devices via a security server;
receive, via the graphic user interface, a configuration of an action for the first interface component with respect to the one or more security devices;
display the first interface component on the web application user interface, wherein the interface component communicates with the one or more security devices via the security server in real time; and
receive input for the one or more security devices from the user via the web application user interface.

9. The apparatus of claim 8, wherein the interface component is a card configured to display a real-time result of a query to the security server.

10. The apparatus of claim 8, wherein the at least one processor is configured to execute the instructions to deploy the web application user interface to a client device.

11. The apparatus of claim 8, wherein the layout for the web application user interface defines a plurality of predefined positions, wherein receiving the selection of the first interface component comprises receiving a selection of a size of the first interface component as a number of the plurality of predefined positions.

12. The apparatus of claim 8, wherein the at least one processor is configured to execute the instructions to:
receive a selection of a second interface component and a second location for the second interface component on the layout for the web application user interface from the user via the graphic user interface, the interface component associated with one or more security devices via the security server;
receive, via the graphic user interface, a configuration of a second action for the second interface component with respect to the one or more security devices; and
display the second interface component on the web application user interface along with the first interface component.

13. The apparatus of claim 8, wherein the first interface component is a swipe and show interface component that displays a record of users providing identification to the one or more security devices.

14. The apparatus of claim 8, wherein the graphical user interface comprises a plurality of selectable buttons for selecting an interface component, wherein each button corresponds to one or more of:
an event interface component configured to display events detected by one or more of the security devices;
an identification interface component configured to display information associated with an identification reader;
a personnel monitoring interface component configured to display information about a person;
a device action interface component configured to receive input to manually control a security device;
a system monitoring interface component configured to display system statistics;
a video monitoring interface component configured to display and control one or more video feeds;
an alert interface component configured to generate an alert; or
a card interface component configured to present a result of a database query.

15. A security system comprising:
one or more security devices configured to monitor an area and control access to the area;
a security server configured to receive information from the one or more security devices and issue commands to the one or more security devices;
a node server configured to:
receive a selection of a first interface component and a location for the interface component on a layout for a web application user interface from a first user via a graphic user interface, the first interface component associated with one or more security devices via a security server;
receive, via the graphic user interface, a configuration of an action for the first interface component with respect to the one or more security devices; and
a client device configured to:
display the first interface component on the web application user interface, wherein the interface component communicates with the one or more security devices via the security server in real time; and
receive input for the one or more security devices from a second user via the web application user interface.

16. The security system of claim 15, wherein the interface component is a card configured to display a real-time result of a query to the security server.

17. The security system of claim 15, wherein the node server is configured to deploy the web application user interface to the client device.

18. The security system of claim 15, wherein the layout for the web application user interface defines a plurality of predefined positions, wherein the node server is configured to receive a selection of a size of the first interface component as a number of the plurality of predefined positions.

19. The security system of claim 15, wherein the first interface component is a swipe and show interface component that displays a record of users providing identification to the one or more security devices.

20. The security system of claim 15, wherein the graphical user interface comprises a plurality of selectable buttons for selecting an interface component, wherein each button corresponds to one or more of:
an event interface component configured to display events detected by one or more of the security devices;
an identification interface component configured to display information associated with an identification reader;
a personnel monitoring interface component configured to display information about a person;
a device action interface component configured to receive input to manually control a security device;
a system monitoring interface component configured to display system statistics;
a video monitoring interface component configured to display and control one or more video feeds;
an alert interface component configured to generate an alert; or
a card interface component configured to present a result of a database query.
